(19) United States
(12) Patent Application Publication
(10) Pub. No.: US 2002/0018621 A1
(43) Pub. Date: Feb. 14, 2002

(54) Optical fiber grating fabrication apparatus for minimizing diffraction effect

(76) Inventor: Moo-Youn Park, Kwangmyong-shi (KR)

Correspondence Address: KLAUBER & JACKSON, 411 HACKENSACK AVENUE, HACKENSACK, NJ, 07601

(21) Appl. No.: 09/911,004

(22) Filed: Jul. 23, 2001

(30) Foreign Application Priority Data
Jul. 25, 2000 (KR) 2000-42700

(51) Int. Cl. G02B 6/34

(52) U.S. Cl. 385/37

(57) ABSTRACT

To fabricate fiber gratings according to the present invention, an optical fiber is prepared, and a mask with a predetermined period is spaced from the optical fiber for forming patterns to be used in fabricating gratings on the optical fiber. Then, a UV light source projects UV light in a perpendicular direction to the optical fiber, while a lens focuses the UV light. At the same time, a mobile concave lens diverges the focused UV light along the length direction of the optical fiber and changes the period of the fiber gratings while moving to and away from the optical fiber.

### CLAIM OF PRIORITY

This application makes reference to and claims all benefits accruing under 35 U.S.C. Section 119 from an application entitled “Optical Fiber Grating Fabrication Apparatus for Minimizing Diffraction Effect” filed in the Korean Industrial Property Office on Jul. 25, 2000 and there duly assigned Serial No. 2000-42700.

### BACKGROUND OF THE INVENTION

1. Field of the Invention

The present invention relates generally to optical fiber gratings, and in particular, to a method and apparatus for fabricating fiber gratings that minimize the diffraction effect.

2. Description of the Related Art

An optical fiber grating acts as a filter to remove or reflect a particular wavelength along the core of the fiber by inducing a periodic change in the refractive index along the fiber using a UV (Ultra Violet) laser. As such, the fiber gratings are divided into short-period fiber gratings and long-period fiber gratings. The short fiber gratings perform the filtering by reflecting light at a predetermined wavelength, whereas the long-period fiber gratings couple the light wave in the core mode to the cladding mode. Due to the capability of coupling light from the core layer to the cladding layer, the long-period gratings are widely used as gain flattening filters for the Erbium Doped Fiber Amplifiers (EDFAs).

The long-period gratings are fabricated by inducing periodic changes in the refractive index of the core of the UV-sensitive optical fiber. The refractive index is changed according to the amount of exposed UV light along the length of the fiber. Using this principle, the fiber gratings are fabricated by transmitting exposure light through a mask. Although the mask is not always used, the usage of a mask is more preferred due to the difficulty in ensuring reproducibility and shortening the duration of the fabrication process.

Currently, there are three known methods to fabricate fiber gratings using a mask, as described below in conjunction with FIG. 1 through FIG. 3.

Referring to FIGS. 1A and 1B, a mask 12 with a predetermined period Λ is disposed away from an optical fiber 10. The UV light 16 emitted from the light source is focused in a perpendicular direction to the length of the optical fiber 10 using a cylindrical concave lens 14. In this method, fiber gratings with only one wavelength band can be fabricated using the mask 22. To fabricate fiber gratings with a different wavelength band, the mask 12 must be replaced. Hence, this method is cost-inefficient and inconvenient.

Referring to FIGS. 2A and 2B, the UV light 28 focused in a perpendicular direction to the optical fiber 20 by the cylindrical convex lens 26 is diverged along the axial direction of the optical fiber 20 through a cylindrical concave lens 24. Shadow patterns created by the mask 22 as the light pass through the cylindrical concave lens 24 and the mask 22 are exposed along the optical fiber 20. Here, the period of the shadow patterns on the optical fiber 20 may be varied by selectively moving the mask 22 to and away from the fiber 20. If the mask 22 approaches toward the cylindrical concave lens 24, the periods of the shadow patterns that are formed on the fiber 20 increase; otherwise, the periods of the shadow patterns decrease. Although diverse wavelength bands can be achieved, this method only has a limited range of periods. Thus, if a larger or smaller period of the fiber gratings is desired, another mask with a different period must be used.

Referring to FIGS. 3A and 3B, the UV light 38 focused in a perpendicular direction along the length of the optical fiber 30 using a cylindrical convex lens 36 is diverged along the axial direction of the optical fiber 30 via a cylindrical concave lens 34. The diverged light passes through the mask 32 so as to expose the shadow patterns of the mask 32 along the optical fiber 30. Similarly, the periods of the shadow patterns on the optical fiber 30 are changeable by moving the mask 32 to and away from the fiber 30. If the mask 32 is moved toward the cylindrical concave lens 34, the period increases, but if the mask 32 is moved toward the optical fiber 30, the period decreases. Because the mask 32 has a plurality of periods Λ1, Λ2, and Λ3, the range of available fiber grating periods is wider, thus minimizing the need to replace the mask 32. However, as the mask 32 moves away from the optical fiber 30 depending on the desired periods of fiber gratings, the diffraction effects are unavoidable. That is, when the mask 32 moves, it results in deterioration of the contrast of the light (difference of the light intensity between an exposed region and a non-exposed region on the mask 32). Thus the resolution is degraded and the transfer of a fine pattern becomes difficult.

As described above, the conventional fabrication methods are not cost-effective and only produce a limited range of periods. In addition, the mask has to be changed whenever the period of fiber gratings must be changed. Furthermore, as the diffraction effects occur in generating different periods of fiber gratings, the manufacturing conditions (e.g., light exposure time) cannot be estimated accurately.

### SUMMARY OF THE INVENTION

It is, therefore, one aspect of the present invention to provide a method and apparatus for fabricating optical fiber gratings which minimize the diffraction effect produced by the mask used in connection with the fabrication of fiber gratings, thereby preventing the deterioration of the spectrum characteristics of the fiber gratings that might otherwise occur.

Another aspect of the present invention is to provide a method and apparatus for fabricating optical fiber gratings that allow the cancellation of the diffraction effect on the edge of the mask patterns such that the resolution and contrast of the pattern definition can be increased.

Another aspect of the present invention relates to a method of fabricating an optical fiber grating. The method may include the steps of: providing a mask having at least one light transmitting region through which exposure light is transmitted; disposing the mask by a predetermined distance away from the optical fiber; directing a light beam on the optical fiber; orienting a first lens so as to focus the light beam in a perpendicular direction to the optical fiber; orienting a second lens so as to intercept the focused light beam from the first lens and to diverge the focused light beam along the lengthwise direction of the optical fiber; and, traversing the second lens along the perpendicular direction to the optical fiber so as to change the light image projected through said mask onto the optical fiber.

To fabricate fiber gratings according to one aspect of the present invention, an optical fiber is prepared, and a mask with a predetermined period is spaced from the optical fiber for forming patterns to be used in fabricating gratings on the optical fiber. Then a UV light source projects UV light in a perpendicular direction to the optical fiber, while a lens focuses the UV light. At the same time, a mobile concave lens diverges the focused UV light along the lengthwise direction of the optical fiber and changes the period of the fiber gratings while moving to and away from the optical fiber.

To fabricate fiber gratings according to another aspect of the present invention, an optical fiber is prepared, and an integrated multi-period mask is spaced from the optical fiber for forming patterns to be used in fabricating gratings in a selected period on the optical fiber. Then a UV light source projects UV light in a perpendicular direction to the optical fiber, a lens focuses the UV light, and a mobile concave lens diverges the focused UV light along the length direction of the optical fiber and changes the period of the fiber gratings while moving to and away from the optical fiber.

### BRIEF DESCRIPTION OF THE DRAWINGS

A more complete understanding of the method and apparatus of the present invention may be had by reference to the following detailed description when taken in conjunction with the accompanying drawings wherein:

FIG. 1A is a schematic view of a conventional optical fiber grating fabrication apparatus;

FIG. 1B is a side view illustrating the conventional optical fiber grating fabrication apparatus shown in FIG. 1A;

FIG. 2A is a schematic view of another conventional optical fiber grating fabrication apparatus;

FIG. 2B is a side view illustrating the conventional optical fiber grating fabrication apparatus shown in FIG. 2A;

FIG. 3A is a schematic view of another conventional optical fiber grating fabrication apparatus;

FIG. 3B is a side view illustrating the conventional optical fiber grating fabrication apparatus shown in FIG. 3A;

FIG. 4A is a schematic view of an optical fiber grating fabrication apparatus according to a preferred embodiment of the present invention;

FIG. 4B is a side view illustrating the optical fiber grating fabrication apparatus according to the preferred embodiment of the present invention;

FIG. 5A is a schematic view of an optical fiber grating fabrication apparatus according to another preferred embodiment of the present invention; and,

FIG. 5B is a side view illustrating the optical fiber grating fabrication apparatus according to the second preferred embodiment of the present invention.

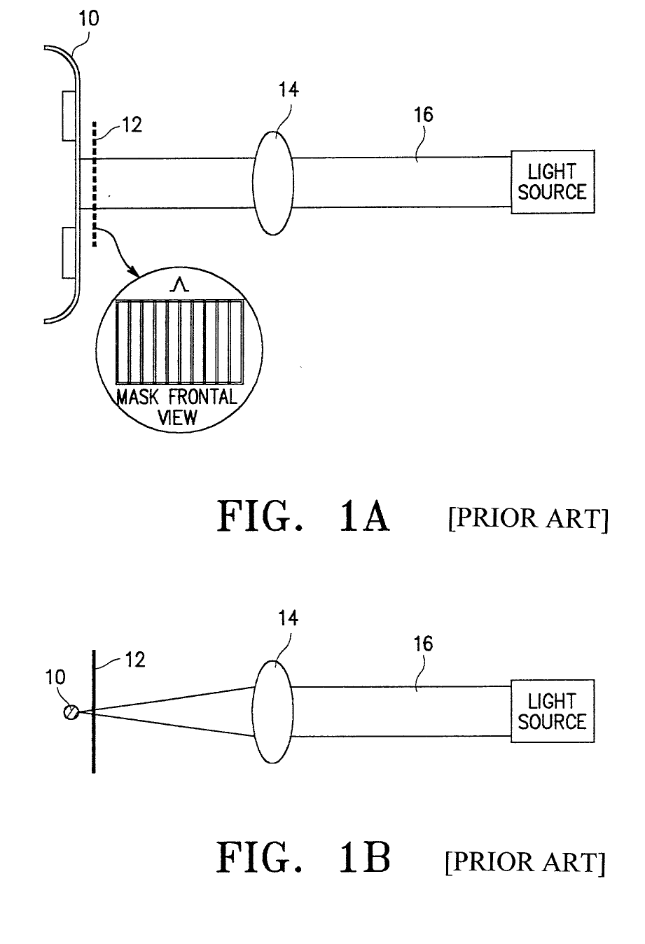

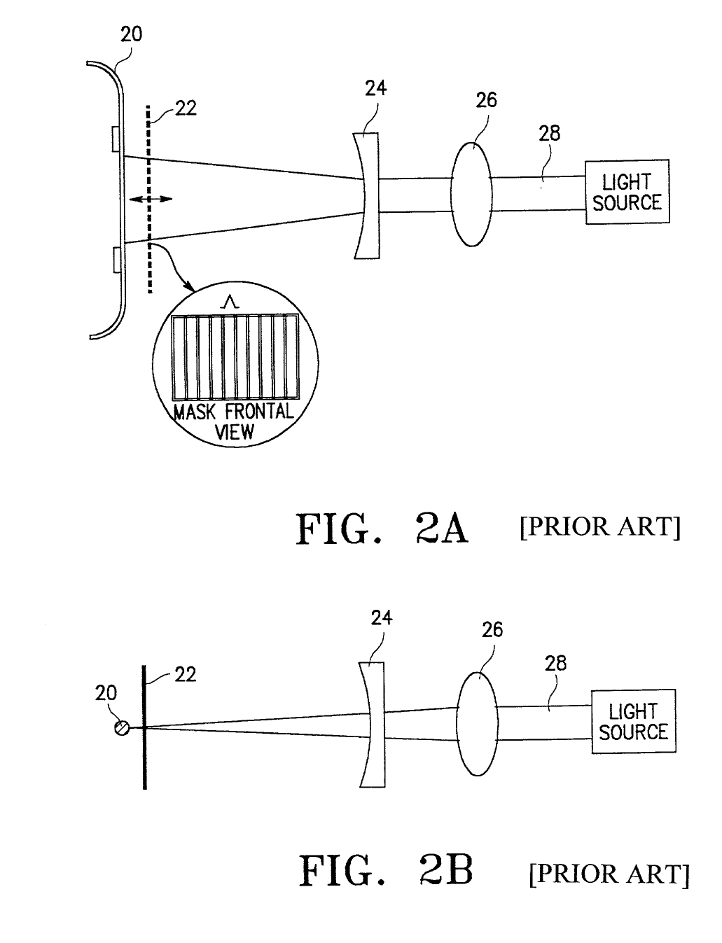

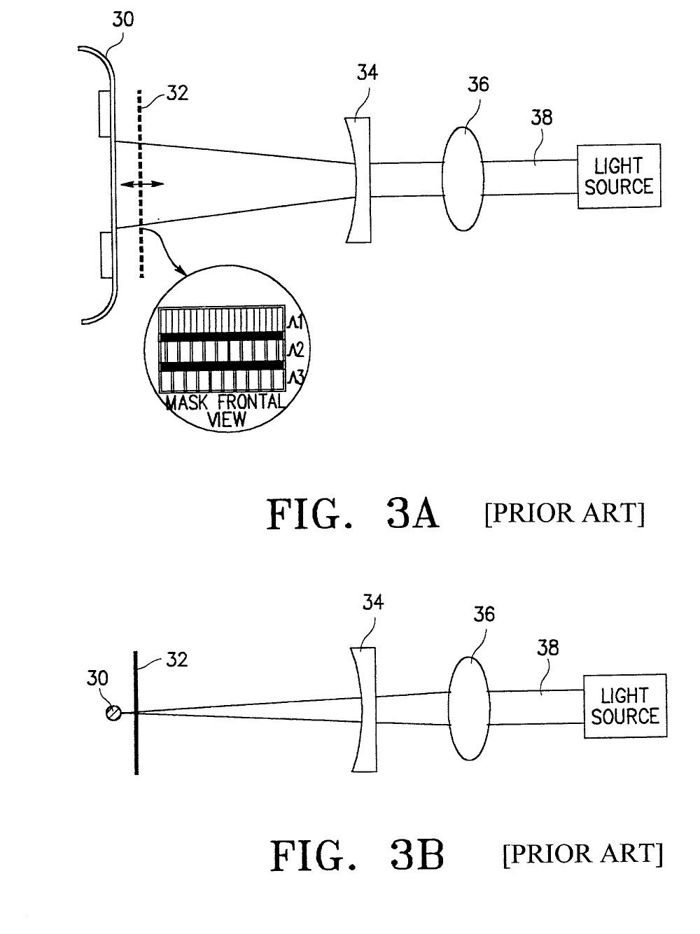

### DETAILED DESCRIPTION OF THE PREFERRED EMBODIMENTS

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

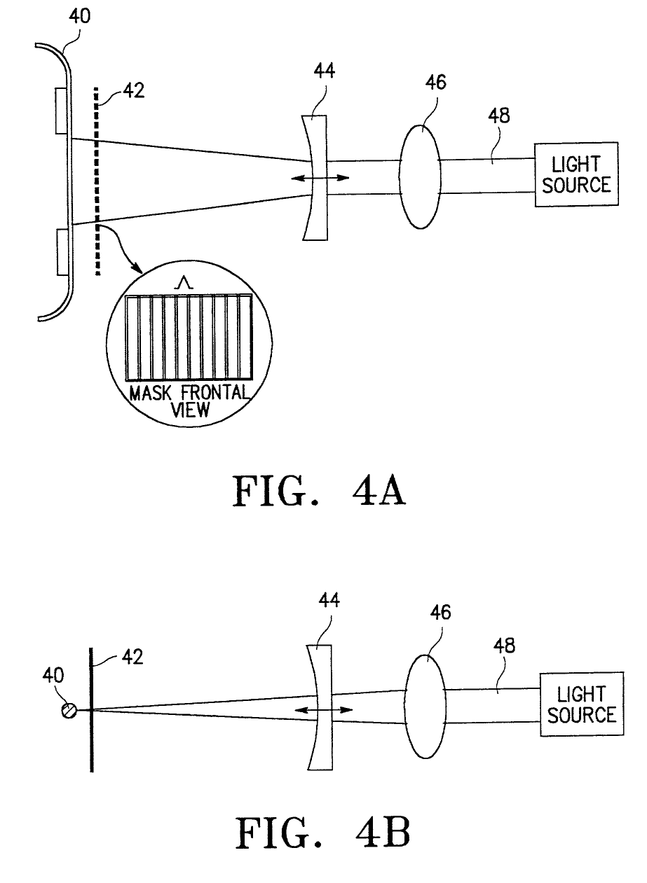

FIG. 4A is a schematic view of an optical fiber grating fabrication apparatus according to a preferred embodiment of the present invention, and FIG. 4B is a side view illustrating the inventive apparatus shown in FIG. 4A. As shown in FIGS. 4A and 4B, the fabrication apparatus according to the first embodiment of the present invention includes an optical fiber 40 mounted on a movable means; a mask 42 for forming patterns to be used in the fabrication of gratings along the direction of the optical fiber 40; a UV light source for emitting UV light 48; a lens 46 for focusing the UV light 48; and, a mobile concave lens 44 for diverging the focused UV light along the axial direction of the optical fiber 40. The mask 42 has a predetermined period Λ.

In the embodiment, the mask 42 is fixed at a predetermined location away from the optical fiber 40 as close as possible to the optical fiber 40, so that the fiber grating period Λ can be changed by moving the mobile concave lens 44 (indicated by arrow). The narrow distance between the mask 42 and the optical fiber 40 help minimize the diffraction effect in the present invention. As a result, when the light is directed to the region of the fiber 40, a consistent contrast of the light can be projected onto the fiber 40 as the mask 42 is not moving. Hence, the resolution is not degraded. Furthermore, there is no need for controlling the duration of light exposure to cancel the diffraction effect as the mask 22 is spaced apart from the fiber grating 40 by a fixed distance.

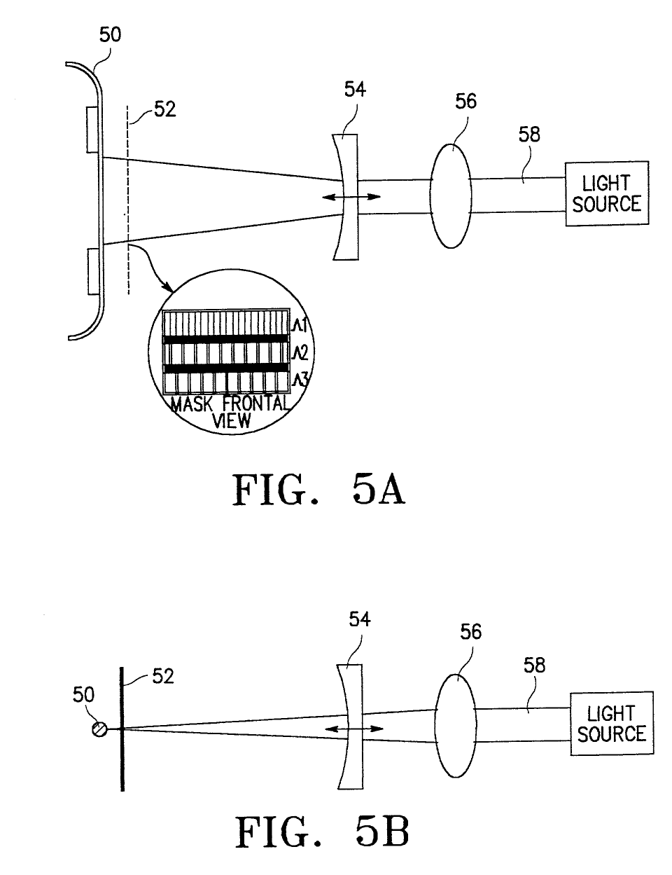

FIG. 5A is a schematic view of an optical fiber grating fabrication apparatus according to another preferred embodiment of the present invention, and FIG. 5B is a side view illustrating the inventive apparatus shown in FIG. 5A. As shown in FIGS. 5A and 5B, the inventive apparatus according to the second embodiment of the present invention includes an optical fiber 50 mounted on a fiber support means; a mask 52 for forming the patterns to be used in the fabrication of gratings along the direction of the optical fiber 50; a UV light source for emitting the UV light 58; a lens 56 for focusing the UV light 58; and, a mobile concave lens 54 for diverging the focused UV light along the axial direction of the optical fiber 50. The mask 52 has an integrated multi-period mask with varying periods Λ1, Λ2, and Λ3, and light passes through the selected period during operation.

In the embodiment, the mask 52 is fixed at a specified distance away from the optical fiber 50. Preferably, the mask 52 is located as close as possible to minimize the diffraction effect as discussed above. According to the embodiment of the present invention, the fiber grating period is changed by moving the mobile concave lens 54 (indicated by arrow) to and away from the fiber 50. As the mask 52 is spaced apart from the fiber grating 50 by a fixed distance, there is no need for controlling the duration of the light exposure as in the conventional method. This is because the change in the distance between the mask and the optical fiber cause varying diffraction effects in the prior art systems. Furthermore, if the grating period projected on the fiber 50 becomes too large or too small in a given period, for example, Λ1, during operation, a different period can be selected by adjusting the height of the mask 52 to have a projected area with a different period.

As is apparent from the foregoing, the present invention has an advantage in that the diffraction effects are reduced, and that there is no need for controlling the light illumination to improve the deterioration of the spectrum characteristics of the fiber gratings as the fiber gratings are fabricated with a mask that is spaced from the optical fiber by a fixed distance. This allows the cancellation of the diffraction effect on the edge of the mask patterns such that the resolution and contrast of the pattern definition can be increased. As a result, the manufacturing conditions, including the duration of the light illumination and others, can be estimated relatively accurately, thereby facilitating the fabrication of fiber gratings.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. An apparatus for fabricating an optical fiber grating, comprising:
an optical fiber;
a light source for projecting a light beam in a perpendicular direction to the optical fiber;
a mask having an array of elongated openings spaced apart by a predetermined interval period through which the light beam from said light source is transmitted;
a lens interposed between said optical fiber and said light source for focusing the light beam; and,
a mobile lens, disposed to intercept the focused light beam from said lens, for diverging the focused light beam along the lengthwise direction of said optical fiber.

2. The apparatus of claim 1, wherein the shape of said mobile lens is concave.

3. The apparatus of claim 1, wherein the image of light projected through said mask changes as said mobile lens moves toward or away from said optical fiber.

4. The apparatus of claim 1, wherein said mask is spaced apart from said optical fiber by a pre-specified distance.

5. An apparatus for fabricating an optical fiber grating, comprising:
an optical fiber;
a light source for projecting a light beam in a perpendicular direction to said optical fiber;
an integrated multi-period mask through which the light beam from said light source is transmitted, said mask spaced apart from said optical fiber by a predetermined distance;
a lens interposed between said optical fiber and said light source for focusing the light beam; and,
a movable concave lens, disposed to intercept the focused light beam from said lens, for diverging the focused light beam along the lengthwise direction of said optical fiber.

6. The apparatus of claim 5, wherein said mask includes a number of an array of elongated openings spaced apart by a predetermined interval period.

7. The apparatus of claim 5, wherein the image of light projected through said mask changes as said mobile lens moves toward or away from said optical fiber.

8. A method for fabricating an optical fiber grating, the method comprising the steps of:
providing a mask having at least one light transmitting region through which exposure light is transmitted;
directing a light beam on an optical fiber;
orienting a first lens so as to focus the light beam in a perpendicular direction to said optical fiber;
orienting a second lens so as to intercept the focused light beam from said first lens and to diverge the focused light beam along the lengthwise direction of said optical fiber; and,
traversing said second lens along said perpendicular direction so as to change the light image projected along said optical fiber through said mask.

9. The method of claim 8, further comprising the step of positioning said mask at a fixed location away from said optical fiber by a predetermined distance.

10. The method of claim 8, wherein said mask includes at least one array of elongated openings spaced apart by a predetermined interval period.

11. The method of claim 8, wherein the shape of said second lens is concave.
